(19) United States
(12) Patent Application Publication
(10) Pub. No.: US 2012/0238719 A1
(43) Pub. Date: Sep. 20, 2012

(54) ASSOCIATIVE ACID SWELLABLE THICKENERS

(75) Inventor: Venkataram Krishnan, Cary, NC (US)

(73) Assignee: Mallard Creek Polymers, Inc., Charlotte, NC (US)

(21) Appl. No.: 13/421,460

(22) Filed: Mar. 15, 2012

Related U.S. Application Data
(60) Provisional application No. 61/452,799, filed on Mar. 15, 2011.

(51) Int. Cl. C08F 222/22

(52) U.S. Cl. 526/312

(57) ABSTRACT

Provided is a thickener composition comprising the polymerization product of an aromatic monomer, an amine functional monomer, and a hydrophobic, associative monomer. The thickener composition is capable of thickening various formulations at a pH of 6.0 or less. Also provided are personal care, household, and industrial formulations that include the thickener compositions.

### CROSS-REFERENCE TO RELATED APPLICATIONS

This application claims priority to U.S. Provisional Application No. 61/452,799, filed Mar. 15, 2011.

### BACKGROUND OF THE INVENTION

Thickener compositions or rheology modifiers are used in industrial, household, and personal care applications to provide a more viscous formulation and to provide a specific kind of rheological profile depending on the application. While there are some examples of acid swellable emulsions, these typically are based on a combination of an acrylate/methacrylate monomer, an amine monomer and a monomer containing the hydrophobic group. This hydrophobic group containing monomer is most often an acrylate/methacrylate monomer with the hydrophobic group attached through a urethane, or monocarboxylic ester functionality. In cases where the hydrophobic group containing monomer has a dicarboxylic acid or anhydride moiety, the hydrophobe is attached similarly leaving one acid functionality free. The dicarboxylic acid monomer, when utilized, is usually based on itaconic acid since such an acid copolymerizes more easily with the acrylate/methacrylate monomers.

The most common examples of currently available thickener compositions are often based on alkali swellable carboxylated polymers. Variations of these compositions have been known for a very long time and usually begin to thicken, become transparent and fully hydrated only around a pH of 6.0 to 7.0. Such behavior causes difficultly in preparing formulations around the physiological pH of 4.0 to 5.0 and at even lower pH since the alkali swellable emulsions do not work effectively at low pH. While some strategies have been developed to address the issue at a pH of 4.0 to 5.0, it is usually unsatisfactory when it comes to efficiency, clarity and suspension of particles. Also, the use of preservatives that are more benign and efficient in this lower pH range is not possible since it has been difficult to provide meaningful thickening in this pH range. Currently available thickener compositions based on alkali swellable carboxylated polymers also exhibit a tendency to thin down to the viscosity of water in the presence of salt, surfactants, acid, cationic components or a combination thereof since such components interfere with the swelling behavior of the polymer. Since most personal care formulations have both salt and surfactants, a significant challenge exists to produce efficient, thickened formulations that remain opaque or transparent while retaining a viscous nature capable of suspending solid components (e.g., beads) which are used for aesthetic purposes and for delivering active ingredients. The currently available acid swellable thickener compositions are also not efficient in terms of providing enhanced association with surfactants and, hence, are not very efficient thickeners in high surfactant formulations. As a result, more of the polymer must be used to achieve efficient thickening and to provide the required rheology. Thus, there exists a need for a thickener composition that provides efficient thickening performance in the presence of surfactant, acid and salt loads and is capable of suspending solid components.

### SUMMARY OF THE INVENTION

Provided is a thickener composition that includes a polymer that is the polymerization product of an aromatic monomer, an amine monomer (monomer having amine functionality), and a hydrophobic monomer. In a preferred embodiment, the aromatic monomer is styrene. In another preferred embodiment, the amine functional monomer is dimethylaminoethyl methacrylate. In yet another preferred embodiment, the hydrophobic monomer is comprised of the reaction product of maleic anhydride and an alkoxylated alkylalcohol. In a preferred embodiment, the reaction product is a maleic-based half ester. In another embodiment, the hydrophobic monomer is a urethane-based monomer. In another embodiment, the hydrophobic monomer is a monoester of acrylic/methacrylic acid. In one embodiment, the thickener composition is completely free of any acrylate or methacrylate monomers other than the amine functional monomers but may comprise other monomers such as, for example, butadiene. The present thickener composition efficiently thickens personal care formulations at a physiological pH of about 4.0 to about 5.0 and lower. The present thickener can also be used to thicken other formulations used in typical household and industrial products where the product needs to be used at a pH below 6.0.

A composition for increasing the viscosity of a personal care, household, or industrial formulation having a pH at or below 6.0 is also provided. The composition includes a polymer comprising from 20% to 30% of an aromatic monomer based on total monomer weight, 55% to 65% of an amine monomer based on total monomer weight, and 10% to 20% of a hydrophobic monomer based on total monomer weight. In a preferred embodiment, the aromatic monomer is styrene. In another preferred embodiment, the amine functional monomer is dimethylaminoethyl methacrylate. In yet another preferred embodiment, the hydrophobic monomer is a maleic-based half ester. In one embodiment, the formulation includes at least one salt, surfactant, acid or anionic polymer.

A personal care product comprising the thickener composition is also provided. The personal care product includes a formulation such as a hair depilatory, sunscreen, cosmetic, deodorant, hand sanitizer, shampoo, gel, cream, body wash, and lotion, serum, facial peel, antiacne, each of which can be for adapted for use on the skin, hair, or other part of the human body. In one embodiment, the pH of the formulation is between about 4.0 and 5.0. In another embodiment the formulation pH can be lower than 4.0 especially where it is used for facial peels or antiacne formulations. In another embodiment, the personal care formulation could be a hydroalcoholic solution that contains a fragrance. Polymers based on this invention have the potential to be used in opaque or transparent formulations for fragrance extension or fragrance delivery on skin, hair etc.

A household or industrial product comprising the thickener composition is also provided. The household or industrial product includes a formulation such as a lubricant, corrosion inhibitor, paste, mastic, coating, adhesive, sealant, cement, mortar, cleaner, disinfectant, laundry aids, fabric softeners, and dishwashing aids. In one embodiment, the pH of the formulation is below about 6.0.

### DETAILED DESCRIPTION OF THE INVENTION

As used herein the term “thickener” refers to the relative increase in viscosity or thickening effect produced by the addition of a minimum amount of the instant polymer as compared to the viscosity produced by a same amount of another polymer or thickening agent.

As used herein the term “synergy” or “synergistic” refers to the ability of the instant polymer to be combined with another component (e.g., salt, acid, surfactant, anionic polymer) to produce a result not independently obtainable.

The thickener composition provided herein efficiently thickens personal care, household, and industrial formulations and exhibits significant association with commonly utilized surfactants that typically contain an alkoxylated hydrophobe group such as, for example, ammonium laureth sulfate, and sodium lauryl ether sulfate (SLES). Even certain nonionic surfactants (e.g. alkoxylated alcohols) have this enhancing effect. The present thickener composition enables the production of thickeners that are highly efficient at lower amounts of polymer and at very high surfactant/polymer ratios. Thus, the present thickener composition provides significant associative, synergistic stability and viscosity stability in the presence of large amounts of surfactants. Like heavy surfactant loads, salts also traditionally negatively affect the thickening and overall viscosity of conventional alkali swellable thickeners as well as acid thickeners. The present thickener composition, in turn, provides significant associative, synergistic and viscosity enhancing ability in the presence of large amounts of salts such as, for example, sodium chloride, sodium sulfate or ammonium chloride.

The present thickener composition also exhibits associative behavior and synergistic effects in the presence of various other commercially available carboxylic acid polymers that are traditionally added to thicken personal care, household, and industrial formulations. Thus, the present thickener composition provides a means to synergistically affect the behavior of the thickener in the presence of salts, surfactants, other commercially available polymers, or a combination thereof. Due to these demonstrated properties, the present thickener composition provides wide latitude in formulations and the possibility to use much less polymer to achieve the same end goals thereby reducing manufacturing costs and environmental impact.

The present thickener composition may be used to produce materials that have shear-thinning, Newtonian, or rheopectic rheology by changing the composition of the polymer and the formulation ingredients that are added. The present thickener composition may be used to thicken latex compositions that are susceptible to hydrolysis under alkaline conditions. In one embodiment, the thickener composition can be used to thicken vinylacetate based latices which typically are formulated around a pH of about 4.0 to about 5.0 due to the hydrolytic instability of the vinylacetate functionality.

The present thickener composition also enables the formulation of products that have rheological profiles that vary from the viscosity of a gel to an embodiment or product with the viscosity of honey. The present thickener composition also significantly aids in suspending solid components (e.g., beads) in a more efficient manner in the pH range 4.0 to 5.0 or lower compared to the currently available technologies while effectively dispersing hydrophobic components without any separation or instability. The present thickener composition is also very compatible with both anionic and cationic components (e.g., polymers or surfactants) that exist in a typical personal care formulation and, hence, can provide transparent or opaque products without significant reduction in the efficiency.

The present thickener composition includes a polymer that is the polymerization product of an aromatic monomer, an amine functional monomer, and an associative, hydrophobic monomer. The amount of thickener composition required to effectively thicken a particular formulation depends upon the particular polymer composition and the end purpose of the formulation. In a preferred embodiment, the aromatic monomer is styrene. In one embodiment, the aromatic monomer is typically present in an amount of about 5% to about 90% based on total monomer weight. In a preferred embodiment, the aromatic monomer is typically present in an amount of about 10% to about 60% based on total monomer weight. In a particularly preferred embodiment, the aromatic monomer is typically present in an amount of about 20% to about 30% based on total monomer weight.

In another preferred embodiment, the amine functional monomer is dimethylaminoethyl methacrylate. In one embodiment, the amine functional monomer is present in an amount of about 15% to about 90% based on total monomer weight. In a preferred embodiment, the amine functional monomer is present in an amount of about 35% to about 75% based on total monomer weight. In a particularly preferred embodiment, the amine functional monomer is present in an amount of about 55% to about 65% based on total monomer weight.

In one embodiment, the associative, hydrophobic monomer is present in an amount of about 1% to about 40% based on total monomer weight. In one embodiment, the associative, hydrophobic monomer is present in an amount of about 5% to about 30% based on total monomer weight. In one embodiment, the associative, hydrophobic monomer is present in an amount of about 10% to about 20% based on total monomer weight.

In one embodiment, the associative, hydrophobic monomer includes acid monomers such as monobasic acids as acrylic, methacrylic, and crotonic, Dibasic acid monomers include maleic acid. In one embodiment, the hydrophobic monomer is comprised of the reaction product of maleic anhydride and an alkoxylated alcohol. In a preferred embodiment, the reaction product is a maleic-based half ester. In another embodiment, the hydrophobic monomer is a urethane-based monomer. In another embodiment, the hydrophobic monomer is a monoester of acrylic/methacrylic acid. In another embodiment, the hydrophobic monomer is an ethylenically unsaturated copolymerizable monomer obtained by condensing a nonionic surfactant with an ethylenically unsaturated carboxylic acid or the anhydride thereof.

The present thickener composition is completely free of any acrylate or methacrylate monomers other than the amine functional monomers (i.e., dimethylaminoethyl methacrylate). Styrene allows the utilization of the beneficial properties of a maleic anhydride based associative monomer without the need to use additional acrylate or methacrylate monomers. The thickener composition may comprise other monomers such as, for example, butadiene. The use of the monomers disclosed herein allows the beneficial copolymerization with the amine monomers since these monomers copolymerize well thereby resulting in a new type of associative acid swellable thickener that may be prepared in an efficient manner.

The present thickener composition may be prepared by initiating an emulsion polymerization of an aqueous composition comprising an aromatic monomer, an amine functional monomer, and an associative, hydrophobic monomer. Polymerization may be carried out in the presence of the associative maleic based monomer. Specifically, high amounts of maleic half ester can be incorporated thereby allowing control of the hydrophobic monomer which cannot be achieved if an acrylate/methacrylate monomer is used in place of styrene. This is due to the ease of copolymerization between styrene and the maleic ester unlike that seen with acrylate/methacrylate monomers and the maleic ester. The present thickener composition may be prepared via an entirely water-based method with no other diluents or solvents compared to traditional methods which utilize diluents (e.g. alkyl ethers) and alcohols, while resulting in stable emulsions. In one embodiment, the method is carried out in a batch process.

In use, the thickener composition is utilized for thickening various formulations at a pH of about 6.0 or less. In one embodiment, the thickener composition efficiently thickens personal care formulations at a physiological pH of typically less than 5.0 or from about 4.0 to about 5.0. The present thickener composition can also be used to thicken other formulations used in typical household and industrial products where the product needs to be used at a pH of typically below about 6.0.

Due to potential antimicrobial properties, the thickener composition can also be used for odor control applications in personal care formulations and in some cases for odor suppression by binding odor causing components. Other suitable formulations include those commonly used in personal care formulations including, but not limited to, shampoos, pastes, gels, creams, body washes or scrubs, and lotions, each of which can be for adapted for use on the skin, hair, or other part of the body. Other formulations include antiaging products, toothpastes or tooth polish, mouthwash, skin tanning products, sun block, sunscreen, insect repellants, itch relief products, foot care products, hand sanitizers, hair depilatories, cosmetics, deodorants, bubble bath, bath powder, nail care products, and pharmaceuticals or pharmaceutical excipients. The present thickener composition may be incorporated into a personal care formulation at the time the formulation is created, or the present thickener composition may be post-added to an existing personal care formulation. The present thickener composition can easily also be converted to a powder for delivery in a solid form as opposed to an emulsion.

The choice and amount of ingredients in formulated compositions containing the present thickener composition will vary depending on the product and its function, as is well known to those skilled in the formulation arts. Formulation ingredients for personal care and topical health care products typically can include, but are not limited to, solvents and diluents (including water), anionic, cationic, amphoteric, and nonionic surfactants (as cleansing agents, emulsifying agents, foam boosters, hydrotropes, solubilizing agents, and suspending agents), nonsurfactant suspending agents, emulsifiers, skin conditioning agents (e.g., emollients, humectants, and moisturizers), auxiliary rheology modifiers and viscosity adjusting agents, hair conditioning agents, hair fixatives, film-formers, skin protectants, binders, chelating agents, antimicrobial agents, antifungal agents, antidandruff agents, abrasives, adhesives, absorbents, dyes, deodorant agents, antiperspirant agents, opacifying and pearlizing agents, antioxidants, preservatives, propellants, spreading aids, sunscreen agents, sunless skin tanning accelerators, ultraviolet light absorbers, pH adjusting agents, botanicals, hair colorants, oxidizing agents, reducing agents, skin bleaching agents, pigments, physiologically active agents, anti-inflammatory agents, topical anesthetics, fragrance and fragrance solubilizers.

The present thickener composition exhibits unique dispersing and emulsifying properties and can be used for dispersing pigments or dyes as well as hydrophobic materials such as oils. The present thickener composition, when combined with surfactants, can be used to boost foaming properties significantly and formulations can be developed that have enhanced foam density and intensity to be delivered through a pump dispenser or similar device.

The present thickener can also be used for other household or industrial applications where a pH of about 6.0 or less is desired. Such household or industrial applications include, but are not limited to, laundry detergents, dishwashing compositions, fabric softener, pigments, paints, adhesives, sealants, cleaners, and disinfectants.

The thickener composition can also be used in construction applications where the thickener composition can be readily mixed with cement in both the liquid or in powder form. Hence, the thickener composition bestows benefits in the alkaline form as it is made or in the acid thickened form. The thickener composition in its alkaline form does have limited associative properties with surfactants like sodium laurylether sulfate (SLES) but this property is significantly enhanced in the acid form. Various acids can be used to neutralize the emulsion such as, for example, acetic, citric, lactic, glycolic, and salicylic acid.

The present thickener composition may be spray dried into powders or used as such in a liquid form in oil field applications such as in oil well drilling and well stimulation where organic and inorganic salts pose a significant challenge to oil extraction. In such an embodiment, the present formulations are useful in stimulating or modifying the permeability of underground formations.

In another embodiment, the present thickener composition may be used to thicken industrial formulations that are used to produce lubricants, corrosion inhibitors, pastes, mastics, adhesives, sealants and coatings. The present thickener composition may also be used without pH adjustment on the amine side as super plasticizers in cement and mortar formulations. The present thickener composition also has the added advantage of being used in both clear and opaque products and formulations.

### Examples

The invention is further illustrated by the following non-limiting examples. In the following examples, unless otherwise specified, the reagents were obtained from commercial sources. Reference to reagents may include reference to a generic description, a brand or trade name, or both.

### Example 1

### General Procedure for Polymer Synthesis

The polymer of the present examples was prepared by a batch process although other well-known methodologies could be easily adopted. A one liter flask fitted with condenser, thermocouple and agitator was charged with 125 grams of styrene, and 75 grams of the maleic half ester. The maleic half ester was prepared by well known methods involving the reaction of maleic anhydride and a hydrophobically modified alkoxylated monohydric alcohol. The temperature was raised to 115° F. The batch was mixed gently until the half ester was completely dissolved. Then 300 grams of dimethylaminoethyl methacrylate was slowly added while mixing. Subsequently, a mixture comprised of 865 grams of water, 2.80 grams of EDTA (36%), 25.40 grams of a surfactant (Polystep-B11 available from Stepan Chemicals) was added slowly to the reactor while mixing.

Next, 2.5 grams of polyethyleneglycoldimethacrylate and 0.5 grams of tertiary dodecyl mercaptan were also added. The temperature was stabilized at 115° F. before the injection of 0.25 grams of ammonium persulfate and 5 grams of water along with 0.25 grams of sodium formaldehyde sulfoxylate. The batch was reacted until full polymerization through a combination of temperature increases and injection of initiator.

### Example 2

The viscosity of a 4% solution of the polymer is dependant to some extent on the type of acid used and the pH of the solution. The effect of various acids on the polymer of Example 1 is summarized in Table 1.

TABLE 1
Effect of acid on the polymer of Example 1:

| | Viscosity (cps) of 4% polymer solution in water |
|---|---|
| | (pH~4.0)- RV-6 @20 rpm on Brookfield RVT |
| Type of acid | viscometer |
| Citric acid | 4680 (RV-5 @ 20 rpm) |
| Acetic acid | 13400 |
| Lactic acid | 18000 |
| Glycollic acid | 16550 |
| Ascorbic acid | 11500 |
| Mallic acid | 9150 |

The instant polymer thickener composition responds to the addition of certain types of surfactants very favorably. For example, sodium lauryl ether sulfate enhances the thickening efficiency of the instant polymer because of a pronounced associative effect, unlike many thickener compositions on the market. The viscosity increases several fold in the presence of the appropriate amount of this surfactant. Such behavior is beneficial because many formulations in industrial or personal care applications require the use of high levels of surfactants which usually reduces the thickening efficiency of the polymer used as a thickener. Such negative behavior is not observed with the instant polymer. Instead, the instant polymer allows one to use a significantly lesser amount of the polymer as is summarized in Table 2. Specifically, Table 2 shows the synergistic thickening enhancement in the presence of two moles ethoxylated sodium lauryl ether sulfate (SLES).

TABLE 2
Synergistic effect on thickening of
polymer solution with SLES (2-EO)

| | | Viscosity of 4% polymer |
|---|---|---|
| | Viscosity of 4% | (~5 grams dry) solution |
| Type of acid used for | polymer solution | with ~35 grams SLES |
| neutralization | (cps)- RV6@20 rpm | (25%) RV7@20 rpm |
| Citric Acid | 4680 (RV-5 @20 rpm | 47,000 |
| Acetic acid | 13400 | 52,000 |
| Lactic acid | 18000 | 61,800 |
| Ascorbic acid | 11500 | 53000 |
| Glycollic acid | 16550 | 55000 |
| Mallic acid | 9150 | 56800 |

It was observed that viscosity can be significantly enhanced with the polymer of Example 1 in the presence of SLES. Other surfactants or hydrophobic ingredients have a similar effect. An enhanced effect in the presence of salt was also observed. Such behavior is very unusual for thickeners which usually are negatively affected in the presence of certain kinds of surfactants or salts. This salt tolerant effect is shown in Table 3

TABLE 3
Effect of salt on the viscosity of polymer thickener compositions

| | Viscosity of 4% thickened solution in the |
|---|---|
| Polymer | presence of 1% NaCl and 35 gm SLES (2EO) |
| Example-1 | 43350 cps RV6 at 20 rpm |
| Competitive example-1 | 5820 cps RV4@ 20 rpm |
| Competitive example-2 | 7930 cps RV4@20 rpm |
| Competitive example-3 | 210 cps RV2@20 rpm |

Example 1 polymer and competitive Example 2 were pH adjusted with lactic acid to about 4.0 before addition of the other ingredients. Competitive example 1 and 3 were pH adjusted with triethanolamine to a pH of ~6 before addition of salt and surfactant.
Note:
Competitive example-1 = Aqua SF1 (Lubrizol), Competitive sample-2 = Structure Plus (Akzo), Competitive example-3 = Novethix L-10 (Lubrizol).

Thus, the polymer of Example 1 exhibits significant thickening efficiency even in the presence of salt.

### Example 3

A variety of formulations were prepared that include the instant polymer for potential use in personal care, household, and industrial arenas. A first formulation (Formulation 1) was prepared with the polymer of Example 1.

Formulation 1
Effect of thickener made based on Example 1

| | Activity/concentration | Amount used |
|---|---|---|
| Ingredient | % | (grams) |
| Water | — | 135.75 |
| Polymer-Example-1 | 30.0 | 12.3 |
| Lactic acid | 50.0 | 1.95 |
| Cocoamidopropyl betaine | 34.0 | 30.9 |
| PEG-7 Glyceryl cocoate | 100.0 | 3.0 |
| PEG-40 Hydrogenated | 100.0 | 1.8 |
| castor oil | | |
| Sodium laurylether | 25.0 | 108.0 |
| sulfate (2EO) | | |

The viscosity of the final formulation was ˜1000 cps RV2@20 rpm. The pH of the finished formulation was between 4.0 and 4.5. The solution exhibited good clarity. The surfactant loading of Formulation 1 is high compared to standard formulations. For purposes of comparison, the same formulation was prepared with a competitive polymeric thickener (Aqua SF-1 available from Lubrizol) as illustrated in Formulation 2.

Formulation 2
Comparative Formulation

| | Activity/concentration | Amount used |
|---|---|---|
| Ingredient | % | (grams) |
| Water | — | 136.5 |
| Aqua SF-1 | 32.0 | 11.4 |
| Triethanol amine | 100.0 | 18 |
| Cocoamidopropyl betaine | 34.0 | 30.9 |
| PEG-7 Glyceryl cocoate | 100.0 | 3.0 |
| PEG-40 Hydrogenated | 100.0 | 1.8 |
| castor oil | | |
| Sodium laurylether | 25.0 | 108 |
| sulfate (2EO) | | |

The viscosity of the final formulation was ˜80 cps which is an order of magnitude lower than that obtained with the polymer of Example 1. It was observed that the instant polymer exhibits a synergistic effect in the presence of salts and even certain polymers that have an opposite charge (e.g. anionic thickeners) based on carboxylated (e.g. the Carbopol line of thickeners) and sulfonated functionality. This synergistic behavior provides the benefit of changing the rheological profile especially at low shear and provides enhanced thickening and suspension characteristics

A third formulation was prepared with small amounts of salt as illustrated below.

Formulation 3
Effect of salt (NaCl) on formulation viscosity:

| | Activity/Concentration | Amount used |
|---|---|---|
| Ingredient | % | (grams) |
| Water | — | 133.5 |
| Polymer-Example 1 | 30 | 12 |
| Lactic acid | 100 | 1.95 |
| Sodium chloride | 25 | 18.0 |
| Cocoamidopropyl betaine | 34 | 30.9 |
| PEG-7 Glyceryl cocoate | 100 | 3.0 |
| PEG-40 Hydrogenated | 100 | 1.6 |
| castor oil | | |
| Sodium laurylether | 25 | 108 |
| sulfate | | |

The viscosity of the above formulation was 10200 cps and the pH was about 4.3. It was observed that the presence of salt in this formulation exhibited an enhanced effect over that of the polymer alone (Formulation 1) or salt alone (Formulation 5—below). Thus, an unexpected synergistic effect on thickening efficiency was observed.

A fourth formulation was prepared to demonstrate the effect of the addition of an anionic polymer.

Formulation 4
Effect of the addition of an anionic polymer
(Ultrez-20) on formulation viscosity:

| | Activity/Concentration | Amount used |
|---|---|---|
| Ingredients | % | (grams) |
| Water | — | 135.75 |
| Ultrez 20 | ~100 | 0.3 |
| Triethanolamine | 100 | 1.56 |
| Polymer-Example 1 | 30 | 12.0 |
| Lactic acid | 100 | 1.95 |
| Cocoamidopropyl betaine | 34 | 30.9 |
| PEG-7 Glyceryl cocoate | 100 | 3.0 |
| PEG-40 Hydrogenated | 100 | 1.8 |
| castor oil | | |
| Sodium Laurylether | 25 | 108 |
| sulfate | | |

Note: Ultrez 20 is an anionic carboxylated thickener made by Lubrizol.

The viscosity of the finished formulation was about 11150 cps (RV6@ 20 rpm) at a pH of 4.93 and exhibited clarity. The addition of an anionic polymer exhibited a similar synergistic effect as that of adding the salt to the formulation containing the thickener composition of Example 1. Such results are unexpected since the addition of such a polymer would have normally caused instability to the formulation and reduced clarity.

A fifth formulation was prepared to demonstrate the effect of the addition of salt in the absence of the instant thickener composition.

Formulation 5
Effect of salt on the same formulation without
any polymeric thickener composition

| | Activity/Concentration | Amount used |
|---|---|---|
| Ingredient | % | (grams) |
| Water | — | 123 |
| Lactic Acid | 100 | 1.95 |
| Sodium chloride | 25 | 18 |
| Cocoamidopropyl betaine | 34 | 30.9 |
| PEG-7 Glyceryl cocoate | 100 | 3.0 |
| PEG-40 Hydrogenated | 100 | 1.8 |
| castor oil | | |
| Sodium Laurylether | 25 | 108 |
| sulfate | | |

The viscosity of the finished formulation was about 900 cps which is similar to that obtained with the polymer thickener composition in Formulation 1. When the instant polymer was added to the formulation (as in Formulation 3) there was a synergistic increase in viscosity.

It is clear from the above formulations that the thickener composition exhibits beneficial properties in terms of its response to salt and surfactants and also other polymers of opposite charge, namely anionic polymers. The instant thickener composition is effective below a pH of 6 and can be suitably formulated in the physiological pH range of from about 4.0 to about 5.0. The thickener composition also exhibits the ability to boost foam stability and quality of foam in the presence of anionic surfactants. The thickener composition has been shown to have great affinity for negatively charged substrates such as hair and skin and leave a very perceptible and enhanced feel on skin and hair that is pleasant and lubricious. Furthermore the thickener composition exhibits the ability to provide antimicrobial properties and minimize the adhesion of microbes on the skin. Hence, the action of some natural biocidal materials (e.g., sorbic acid) could be enhanced in the presence of these polymers.

While some embodiments have been shown and described, various modifications and substitutions may be made thereto without departing from the spirit and scope of the invention. For example, for claim construction purposes, it is not intended that the claims set forth hereinafter be construed in any way narrower than the literal language thereof, and it is thus not intended that exemplary embodiments from the specification be read into the claims. Accordingly, it is to be understood that the present invention has been described by way of illustration and not limitations on the scope of the claims.

We claim:

1. A thickener composition comprising
a polymer, wherein the polymer is a polymerization product of an aromatic monomer, an amine monomer, and a hydrophobic monomer.

2. The thickener composition of claim 1, wherein the hydrophobic monomer is a reaction product of maleic anhydride and an alkoxylated alcohol.

3. The thickener composition of claim 1, wherein the hydrophobic monomer is a maleic-based half ester of an alkoxylated alkyl alcohol.

4. The thickener composition of claim 1, wherein the hydrophobic monomer is a urethane-based monomer.

5. The thickener composition of claim 1, wherein the hydrophobic monomer is a monoester of acrylic/methacrylic acid.

6. The thickener composition of claim 1, wherein the aromatic monomer is styrene.

7. The thickener composition of claim 1, wherein the amine monomer is dimethylaminoethyl methacrylate.

8. The thickener composition of claim 1, wherein the aromatic monomer is styrene, the amine monomer is dimethylaminoethyl methacrylate, and the hydrophobic monomer is a maleic-based half ester of an alkoxylated alkyl alcohol.

9. The thickener composition of claim 8, wherein the composition is completely free of any acrylate or methacrylate monomers other than the dimethylaminoethyl methacrylate.

10. The thickener composition of claim 1, further comprising at least one butadiene monomer.

11. The thickener composition of claim 1, wherein the thickener composition increases viscosity of a formulation having a pH of between 4.0 and 5.0.

12. The thickener composition of claim 1, wherein the thickener composition increases viscosity of a formulation that includes at least one salt, surfactant, acid or anionic polymer.

13. A composition for increasing the viscosity of a personal care, household, or industrial formulation having a pH at or below 6.0, the composition comprising
a polymer, the polymer comprising from 20% to 30% of an aromatic monomer based on total monomer weight, 55% to 65% of an amine monomer based on total monomer weight, and 10% to 20% of a hydrophobic monomer based on total monomer weight.

14. The composition of claim 13, wherein the hydrophobic monomer is a maleic-based half ester of an alkoxylated alkyl alcohol.

15. The composition of claim 13, wherein the amine monomer is dimethylaminoethyl methacrylate.

16. The composition of claim 13, wherein the formulation further comprises at least one salt, surfactant, acid or anionic polymer.

17. A personal care product comprising the thickener composition of claim 1.

18. The personal care product of claim 17, wherein the personal care product is a formulation selected from the group consisting of hair depilatory, sunscreen, cosmetic, deodorant, hand sanitizer, shampoo, gel, cream, body wash, and lotion, serum, facial peel, antiacne, each of which can be for adapted for use on the skin, hair, or other part of the human body.

19. A household or industrial product comprising the thickener composition of claim 1.

20. The household or industrial product of claim 19, wherein the household or industrial product is a formulation is selected from the group consisting of a lubricant, corrosion inhibitor, paste, mastic, coating, adhesive, sealant, cement, mortar, cleaner, disinfectant, laundry aids, fabric softeners, and dishwashing aids.
